(19) United States
(12) Patent Application Publication
(10) Pub. No.: US 2011/0001462 A1
(43) Pub. Date: Jan. 6, 2011

(54) ELECTRONIC DEVICE AND METHOD FOR DC-DC CONVERSION

(75) Inventors: Michael Couleur, Munich (DE); Lei Liao, Aachen (DE); Neil Gibson, Freising (DE)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/794,585

(22) Filed: Jun. 4, 2010

(30) Foreign Application Priority Data
Jun. 8, 2009 (DE) 10 2009 024 160.4

(51) Int. Cl. G05F 1/56

(52) U.S. Cl. 323/289

(57) ABSTRACT

An electronic device is provided for switched DC-DC conversion of an input voltage level into an output voltage level comprising a driving stage for controlling a control gate of a high side power switch so as to vary the voltage level on a switching node and an auxiliary switch, wherein the auxiliary switch is coupled between the control gate of the power switch and the switching node so as to feed a charge released from the control gate in a switching operation to the switching node.

### CROSS-REFERENCE TO RELATED APPLICATIONS

This patent application claims priority from German Patent Application No. 10 2009 024 160.4 filed Jun. 8, 2009, which is incorporated herein by reference in its entirety. This application is related to co-pending application serial no. ______ (TI-67072) filed on even date which is incorporated herein by reference in its entirety.

### FIELD OF THE INVENTION

The invention relates to an electronic device and a method for DC-DC conversion,

### BACKGROUND

Integrated switched DC-DC converters (e.g. buck, boost or buck/boost converter) have two main types of power losses. One is due to charging and discharging of the control gate (i.e. the gate capacitance) of the power switches (e.g. power MOSFETs). The control gate typically receives an alternating control voltage that varies between the primary voltage supply level (or a higher voltage level depend on the specific type of converter and its architecture) and ground. The alternating voltage levels on the gate capacitance CG cause an average DC current IDC in the gate driving stage flowing from the primary voltage supply (input voltage VIM) to ground GND. The current IDC can be roughly approximated as:

IDC=CG·f·VON (1)

where f is the switching frequency. The power consumption POWC due to this effect is then:

POWC=CG·f·VON² (2)

POWC is proportional to the switching frequency, the gate capacitance CG and the square of the voltage level VON for turning the switch on (high level). IDC can reach several mA, which significantly contributes to the overall power consumption of the DC-DC converter.

The second type of power loss is due to the ON resistance of the power switches. This kind of power loss is resistive and referred to as “RDSON loss”. RDSON refers to the resistance of a power switch when a current is flowing through the switch, i.e. when it is turned on. This power loss can be described as:

PRES=RDSON·IL² (3)

where IL is the load current or output current of the DC-DC converter. The first order approximations of the ON resistance RDSON and the control gate capacitance are

$$\begin{matrix}RDSON = {( μ \cdot Cox \cdot \frac{W}{L} ( Vgs - Vt ) - Vds )}^{- 1} \\ and & ( 4 ) \\ CG = Cox \cdot W \cdot L & ( 5 )\end{matrix}$$

Cox is the gate oxide capacitance per control gate area, μ the mobility of the charge carriers, and W and L the respective width and length of the control gate.

The above equations (2) to (5) show that increasing the dimensions of the power switch (increasing the width W with respect to the length L) may reduce the ON resistance RDSON. Increasing Vgs also decreases the ON resistance RDSON, but this increases POWC as VON is proportional to Vgs. Furthermore, increasing the gate area (W times L) also increases the gate capacitance CG.

This means that a design measure aiming to reduce either of the two power losses POWC or PRES adversely affects the respective other loss.

### SUMMARY

It is an object of the Invention to provide an electronic device and a method for DC-DC conversion with tower power losses due to control gate capacitance and ON resistance of power switches than prior art devices and methods.

Accordingly, an electronic device for switched DC-DC conversion of an input voltage level Into an output voltage level is provided. The input voltage level may relate to an Input power supply or primary power supply (for example from a battery). The output voltage is also referred to as the secondary power supply and used to supply a load with an output voltage and an output current or load current. The electronic device may then advantageously comprise a driving stage for controlling a control gate of a power switch. The switching can cause a variation or alternation of the voltage level on a switching node. There is further an auxiliary switch. The auxiliary switch is coupled between the control gate of the power switch and the switching node. The auxiliary switch is selectively controlled (made conducting) so as to feed a charge released from the control gate in response to a switching operation of the power switch to the switching node.

The released charge may at least partially be the charge of a gate capacitance of a power MOSFET. When switching the power switch, the amount of charge on the control gate can change which results in a current. This may occur when the power MOSFET is turned off. Charge can then be released from the control gate due to switching. According to this aspect of the invention, the current due to flowing charge is not directed to power supply or to ground. The charge may be fed to an internal node of the circuit as, for example the switching node. The energy of the released charge may then be dissipated through heat in the on resistor of a switch used to couple the control gate to the internal node (e.g. the switching node of the DC-DC converter). This requires no or less net current flow from battery to ground.

In a further aspect of the invention, the electronic device (e.g. the driving stage of the electronic device) may comprise a first charge pump for generating a first control voltage level for the control gate of the power switch. The control voltage level may advantageously be greater than the input voltage level (primary power supply) and/or the output voltage level (secondary power supply). Raising the control voltage level of the power switch (e.g. a power MOSFET) decreases the ON resistance and reduces the resistive power losses. However, increasing the control voltage level also increases power consumption due to charging and discharging the control gate (the capacitance of the control gate).

In an embodiment, the electronic device may be configured to switch a high side switch of a DC-DC converter. The high side switch may be a power MOSFET. The high side switch can be Implemented with an NMOS transistor or a PMOS transistor. In an embodiment, the high side switch can be an NMOS transistor. There may also be a low side switch that may be an NMOS transistor. The high side switch may be coupled to the primary supply voltage, i.e. to the input voltage level. The low side switch may be coupled to ground. The DC-DC converter may have a switching node between the high side switch and the low side switch. The switching node may then be configured to be coupled to an inductor. The power switches (high side and low side) may then alternately switched on and off (e.g. with alternating non-overlapping clock signals) for controlling a current through the inductor and generating the output voltage on the other side of the inductor. The electronic device may then include a control stage for controlling duty cycles and/or clock periods of the clock signals for the power switches for controlling an output current (e.g. current through the inductor) and/or the output voltage level. The electronic device may be operated in a current mode, in a voltage mode, or in both and respective current and/or voltage sensing means may be implemented.

The invention can apply to buck converters. Buck converters have a lower output voltage level than input voltage level. The control gate may then be raised even above the input voltage level for switching the power switch on. The power switch may then be the high side power MOS field effect transistor (MOSFET; e.g. NMOS). The control gate may then be configured to be coupled to a switching node between the high side power MOSFET and a low side power switch.

Furthermore, an auxiliary charge pump may be provided for generating an auxiliary control voltage level for the control gate of the auxiliary switch. This provides that the control gate of the power switch can reliably be discharged with low resistive losses. In another embodiment, a single charge pump may be used for driving and controlling the power switch and the auxiliary switch. The single charge pump may then include two flying capacitors for controlling voltage levels for the high side switch and the auxiliary switch. The charge pump may include two inverters coupled to the respective first sides of the two flying capacitors. The other sides of the flying capacitors may then be coupled to the control gates of the high side switch and the control gate of the auxiliary switch, respectively. Both switches can then be controlled with positive voltage levels which are higher than the primary input voltage level. Furthermore, the control signals for the two switches can be basically inverted with respect to each other. This provides that the auxiliary switch is turned on, when the high switch is turned off, and vice versa.

The invention also provides a method of operating a DC-DC converter. A first control voltage level may be applied to a control gate of a power switch so as to reduce an ON resistance of the power switch during a conducting phase of the switch. A charge released from the control gate of the power switch may then be fed to a switching node of the DC-DC converter while turning the power switch off. The charge from the control gate of the power switch may be redirected so as to add to the DC-DC conversion. Further aspects and steps of the method can be derived from the description of the electronic device and the example embodiments of the invention.

### BRIEF DESCRIPTION OF DRAWINGS

Further aspects of the invention will ensue from the following description of preferred embodiments of the invention with reference to the accompanying drawings wherein:

FIG. 1 shows a simplified circuit diagram of a prior art DC-DC converter,

FIG. 2 shows a simplified circuit diagram of an aspect of the invention,

FIG. 3 shows a simplified circuit diagram of an embodiment of the invention; and

FIG. 4 shows simplified circuit diagram of another embodiment of the invention;

### DETAILED DESCRIPTION OF AN EXAMPLE EMBODIMENT

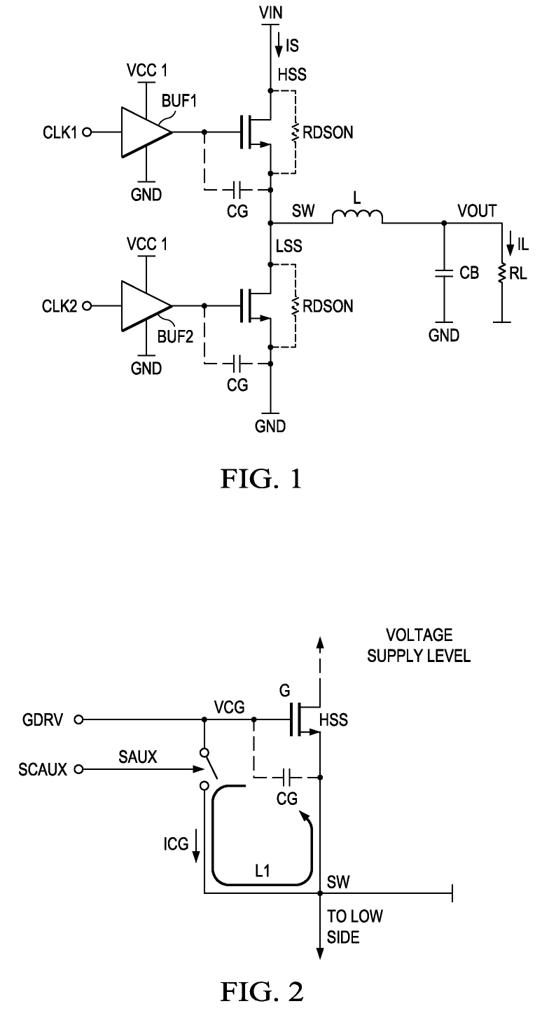

FIG. 1 is a simplified circuit diagram of DC-DC converter according to the prior art. Only the most important components of a DC-DC converter are shown. There is a high side switch HSS and a low side switch LSS. The switches can be implemented as PMOS and NMOS transistors. In this embodiment, both switches are NMOS transistors. The high side switch HSS receives a first clock signal CLK1 through a first buffer BUF1. The low side switch LSS receives a second clock signal CLK2 through a second buffer BUF2. instead of buffers BUF1, BUF2, inverters may be used. The clock signals CLK1, CLK2 may be non-overlapping clock signals. The clock or driving signals CLK1, CLK2 may be pulse width modulated (PWM) signals. The high side switch is coupled to VIN. The low side switch LSS is coupled at a switching node SW to the high side switch HSS and with the other side to ground. An inductor L is also coupled to the switching node SW. If the high side switch HSS and the low side switch LSS are alternately switched on and off, the switching node SW is either pulled towards the input voltage level VIN or towards ground GND. This produces a rising and falling current through the inductor that charges the buffer capacitor CB and establishes an output voltage VOUT. From the output node VOUT a load current IL flows through a load RL.

The power switches HSS and LSS have an inherent finite ON resistance RDSON and an inherent control gate capacitances CG (shown with dashed lines) which can cause the above mentioned undesired power losses POWC and PRES (equations (2) and (3)) through buffers BUF1 and BUF2, which have supply voltage levels VCC1, and ground GND and VCC2 and ground GND respectively.

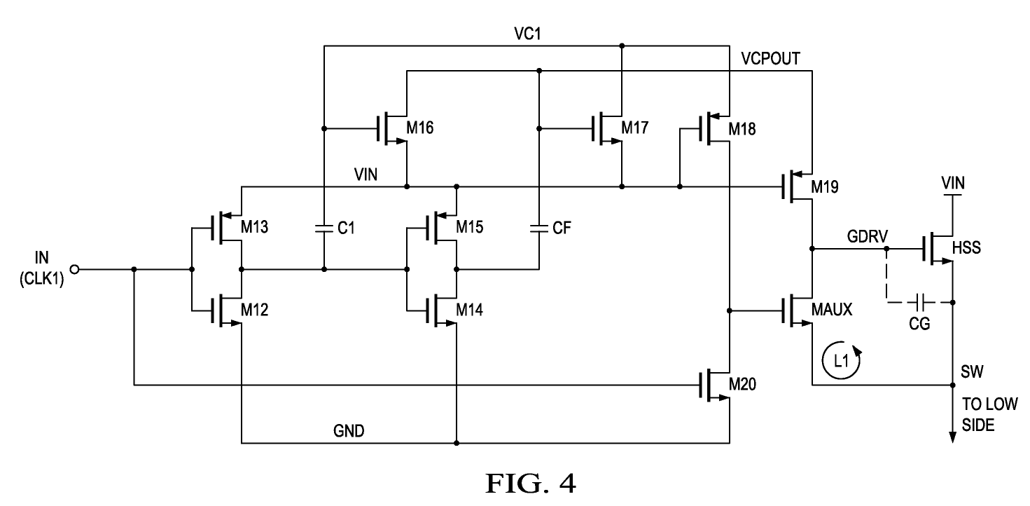

FIG. 2 is a simplified circuit diagram showing an aspect of the invention. A power switch HSS is driven with a gate driving signal GDRV, for example a periodic clock signal or a PWM signal with a frequency f and a specific duty cycle. The gate driving signal GDRV is fed to the control gate G. The control voltage level of the gate driving signal is VCG. An auxiliary switch SAUX is provided and controlled with auxiliary control signal SCAUX. The power switch HSS may now be turned on, by applying a high voltage level VCG so as to reduce the ON resistance RDSON of the power switch. When the power switch HSS is turned off, a charge may be released from parasitic capacitor CG of control gate G. Auxiliary control signal SCAUX may now bring the auxiliary switch SAUX in a conducting state. The input node GDRV may simultaneously be brought in a high impedance state or decoupled to prevent charge from flowing back. The released charge flows through switch SAUX as a current ICG. The current ICG substantially fed to the switching node SW. When high side switch SW is turned on, the charge contributes in recharging the capacitance CG. This means that the released charge or the corresponding current ICG somehow circles around loop L1, rather the flowing to ground or somewhere else. The energy of the released charge can then be held in a loop including the auxiliary switch SAUX and the gate capacitance CG. It may be dissipated through heat in the on resistor of the auxiliary switch. This requires less net current flow from battery to ground. The amount of charge and respective power and energy that can be saved will be derived below with respect to FIG. 4. The advantage already exists if only a small amount of charge is concerned.

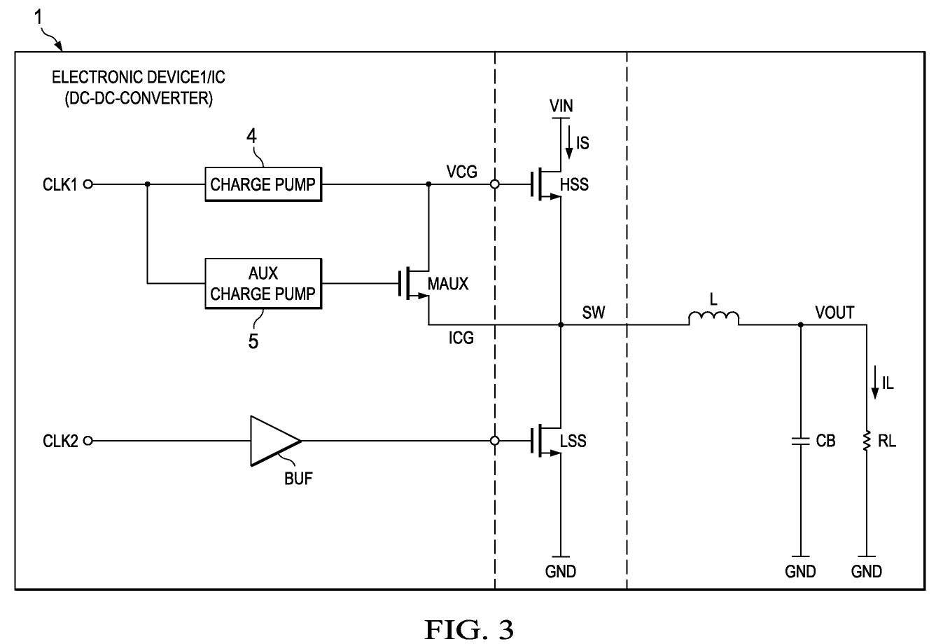

FIG. 3 shows a simplified circuit diagram of a further embodiment of the invention. The electronic device may include an integrated circuit IC which may also be configured to provide the driving signals CLK1, CLK2 for the high side switch LSS and the low side switch HSS of a DC-DC converter. This embodiment provides that charge from the gate capacitance of the high side switch HSS is recirculated Into the circuitry. The energy can then be dissipated through heat in the on resistor of the auxiliary switch MAUX. There is a charge pump 4 and an auxiliary charge pump 5. The charge pumps 4 and 5 receive the first clock signal (driving signal) CLK1. CLK1 and CLK2 may be non-overlapping clock signals. They may be pulse width modulated. Charge pump 4 is coupled to the control gate of the high side switch HSS and provides control voltage VCG. The control voltage VCG can then be raised above the input voltage level VIN. This reduces the ON resistance RDSON of the high side switch HSS. The high side switch HSS is an NMOS transistor in this embodiment. The low side switch LSS is also an NMOS transistor. An auxiliary switch MAUX is coupled between the control gate and the switching node SW between the high side switch HSS and the low side switch LSS. The auxiliary switch MAUX may be an NMOS transistor. The control gate of the auxiliary switch MAUX is coupled to an output of the auxiliary charge pump 5. The auxiliary charge pump 5 generates an appropriate control signal for the auxiliary switch MAUX so as to turn the switch on when the high side switch HSS should be turned off. The output of the charge pump 4 may then be brought in a high impedance state. If the high side switch HSS is turned off a certain amount of charge may be released from the gate capacitance of the control gate. The released charge may then be fed through auxiliary switch MAUX to the switching node. The flowing charge is referred to as a current ICG which flows in a loop consisting of the on resistor of the discharge switch MAUX and the parasitic gate capacitance CG of the high side switch HSS until the energy of the released charge which was initially present on CG is converted into heat in the on resistor of the discharge switch MAUX. This means that there is no net current flow from battery to ground needed to discharge the gate capacitance CG of the high side switch HSS.

The electronic device may advantageously comprise sensing stages for sensing the output voltage level VOUT and/or an output current (e.g. through inductor L) as well as control stages for generating appropriate control signals CLK1, CLK2 based on the sensed values. These stages are well known in the art and therefore not shown in FIG. 3. The dashed lines suggest different configurations for integrated and external components, but the invention is not limited to any of those configurations. An embodiment of an integrated circuit IC may include the control stages for the DC-DC conversion and the driving stages BUF, as well as the charge pump 4 or charge pumps 4, 5 and the auxiliary switch MAUX. The high side and/or low side switch can be integrated or external as well as the inductor L, the buffer capacitor CB and the load RL.

FIG. 4 shows another embodiment of the invention. This embodiment uses a single circuit for the charge pump 4 and the auxiliary charge pump 5 shown in FIG. 3. The charge pump has a first inverter stage including transistors M12 and M13. The input of the inverter receives the clock signal CLK1 at input node IN. The output of the inverter is coupled to a capacitor C1 and to the input of a second inverter having transistors M14 and M15. Both inverter stages M12, M13 and M14, M15 are coupled between the input voltage level VIN and ground GND. The output of the second inverter M14, M15 is coupled to a flying capacitor CF. The other side of the flying capacitor CF is supplied with a current through transistor M16, if the flying capacitor is pulled down to ground through transistor M14 of the second inverter stage. The gate of transistor M16 is controlled through capacitor C1 with a voltage above the input voltage level VIN. Flying capacitor CF is then pulled up by transistor M15. This provides that the other side of the flying capacitor reaches the charge pump output voltage VCPOUT which is about two times the level of the input voltage VIN. A PMOS transistor M19 is coupled between one side (VCPOUT) of the flying capacitor and a node that can be coupled to the control gate of the high side transistor HSS. The parasitic gate capacitance CG of the high side switch is also indicated with dashed lines. The maximum positive gate driving voltage GDRV can be about two times the input voltage level VIN. The high output voltage VCPOUT is also applied to the gate of transistor M17 which is coupled to feed a current from the input voltage supply VIN to capacitor C1, when C1 is pulled to ground through M12. The auxiliary switch MAUX is coupled between node GDRV and the switching node SW. The control gate of the auxiliary switch MAUX is controlled with two transistors M20 and M18. Transistor M20 is an NMOS transistor which receives the input signal CLK1 at the control gate. The source of M20 is coupled to ground. The PMOS transistor M18 is coupled with its drain to the control gate of the auxiliary switch MAUX and with its source to high voltage level side VC1 of capacitor C1. This means that transistor M20 pulls the control gate of the auxiliary switch to ground when the input signal CLK1 is high. Auxiliary switch MAUX is then turned off. If the input signal CLK1 is low, transistor M20 is turned off. Due to inverter M12, M13, capacitor C1 is pulled up with the low voltage level side towards input voltage level VIN. The high voltage level side of capacitor C1 rises up to about two times the input voltage level and a current is fed to the control gate of the auxiliary switch MAUS through transistor M18. The auxiliary transistor MAUX is then open. Basically, the auxiliary switch MAUX is turned on (conducting), when the input signal CLK1 is low, and it is turned off (not conducting), when the input signal CLK1 is high. The high side switch HSS is turned on, when the input signal CLK1 is high and turned off, when CLK1 is low. This provides that the charge from parasitic capacitance CG basically circles around loop L1 instead of flowing to ground or another voltage supply level. The losses are due to the on resistance of auxiliary transistor and other parasitic resistors.

According to an aspect of the invention the circuit can be dimensioned in order to increase the efficiency of the circuit. The capacitance value CF of the flying capacitor may be dimensioned to be x times the parasitic capacitance value CG of the high side switch. Due to charge conservation between the flying capacitor and the parasitic capacitor, the following relationship can be assumed:

x·CG·VIN=(x+1)·CG·V′ (6)

where V′ is the voltage shared by the flying capacitor CF and the gate capacitance CG. This can be used to find a term for V′ as a function of x and VIN:

$${V}^{′} = \frac{x}{x + 1} \cdot VIN \qquad ( 7 )$$

The charge lost by the flying capacitor CF during operation is then:

$$\begin{matrix}Δ Q = x \cdot CG \cdot VIN - x \cdot CG \cdot {V}^{′} \\ = x \cdot CG ( VIN - \frac{x}{x + 1} \cdot VIN ) \\ = \frac{x}{x + 1} \cdot CG \cdot VIN\end{matrix} \qquad ( 8 )$$

The current I required to recharge the flying capacitor CF is then

$$I = AQ \cdot f = \frac{x}{x + 1} \cdot CG \cdot VIN \cdot f \qquad ( 9 )$$

The required power P for recharging the flying capacitor CF is:

$$P = \frac{x}{x + 1} \cdot CG \cdot {VIN}^{2} \cdot f \qquad ( 10 )$$

The corresponding energy E is given as

$$E = \frac{x}{x + 1} \cdot CG \cdot {VIN}^{2} \qquad ( 11 )$$

The effectiveness EFF is the ratio of the energy ECG stored in the gate capacitance and E the energy required to recharge the gate

$$EFF = \frac{ECG}{E} = \frac{\frac{1}{2} \cdot CG \cdot {{V}^{′}}^{2}}{\frac{x}{x + 1} \cdot CG \cdot {VIN}^{2}} = \frac{1}{2} \frac{x}{x + 1} \qquad ( 12 )$$

This means that the effectiveness can be increased if x>>1. This means that the capacitance value of the flying capacitor CF should be much greater then the capacitance value of the gate capacitance. A conventional DC-DC converter, where the control gate of the high side switch is coupled to ground, has only half the effectiveness of the electronic device according to aspects of the invention.

Although the embodiments are primarily described with respect to a buck converter, the same principles may be applied to other types of converters. For different embodiments of the invention it may be necessary to exchange the respective voltage levels (e.g. VIN and VOUT) and/or transistor types (e.g. NMOS with PMOS or vice versa). Although the invention has been described hereinabove with reference to specific embodiments, it is not limited to these embodiments and no doubt further alternatives will occur to the skilled person that lie within the scope of the invention as claimed.

1. An electronic device for switched DC-DC conversion of an input voltage level Into an output voltage level comprising:
a driving stage for controlling a control gate of a high side power switch so as to vary the voltage level on a switching node and an auxiliary switch, wherein the auxiliary switch is coupled between the control gate of the power switch and the switching node so as to feed a charge released from the control gate in a switching operation to the switching node.

2. The electronic device according to claim 1, further comprising a first charge pump for increasing a first control voltage level for the control gate of the power switch so as to reduce an ON resistance of the power switch.

3. The electronic device according to claim 2, further comprising an auxiliary charge pump for generating an auxiliary control voltage level for the control gate of the auxiliary switch.

4. The electronic device according to claim 1 wherein the auxiliary switch is turned on when the high side power switch is to be turned off.

5. The electronic device according to claim 2 wherein the auxiliary switch is turned on when the high side power switch is to be turned off.

6. The electronic device according to claim 3 wherein the auxiliary switch is turned on when the high side power switch is to be turned off.

7. A method of operating DC-DC converter, the method comprising:
applying a first control voltage level to a control gate of a power switch so as to reduce an ON resistance of the power switch during a conducting phase of the switch; and
feeding a charge released from the control gate of the power switch to a switching node of the DC-DC converter while turning the power switch off.
